(19) United States
(12) Patent Application Publication
(10) Pub. No.: US 2009/0274486 A1
(43) Pub. Date: Nov. 5, 2009

(54) Drive roller for imagae forming device

(76) Inventor: Chia-Chiang Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,897

(22) Filed: Oct. 16, 2008

(30) Foreign Application Priority Data
Apr. 30, 2008 (CN) 200810027845.4

(51) Int. Cl. G03G 15/00; G03G 15/01; G03G 15/16

(52) U.S. Cl. 399/162; 399/303; 198/835; 399/302; 399/313

(57) ABSTRACT

A drive roller is adapted for use with an image forming device that includes a conveyer belt trained on the drive roller. The drive roller includes an elongated roller body and symmetrical first and second threads. The roller body has a first segment that has an annular first surrounding surface, and a second segment that is opposite to the first segment, that has a length equal to that of the first segment, and that has an annular second surrounding surface. The first and second threads are formed respectively at the first and second surrounding surfaces, are threaded in opposite directions, and are adapted for contacting the conveyer belt.

### CROSS-REFERENCE TO RELATED APPLICATION

This application claims priority of Chinese Application No. 200810027845.4, filed on Apr. 30, 2008.

### BACKGROUND OF THE INVENTION

1. Field of the Invention

The invention relates to a drive roller, more particularly to a drive roller for an image forming device.

2. Description of the Related Art

A conveyer device for use in a printing device generally includes a drive roller, a driven roller, and a conveyer belt, such as a photoreceptor belt, an intermediate belt, or a transfer belt, trained on the drive roller and the driven roller. The drive roller can be actuated to rotate so as to drive the conveyer belt to move around the drive roller and the driven roller. However, during operation, the conveyer belt may deviate from a normal position along a longitudinal direction of the drive roller due to wear between the conveyer belt and the drive roller or manufacturing error of the printing device, which incurs error of toner adherence or paper positioning, thereby resulting in poor printing quality.

U.S. Pat. No. 6,088,566 discloses a conventional conveying device 1 for an image forming apparatus as illustrated in FIGS. 1 and 2. The conventional conveying device 1 includes a base frame 11, a plurality of rollers 12 mounted rotatably on the base frame 11, and a conveyer belt 13 trained on the rollers 12. The conventional conveying device 1 further includes a regulation component 10 disposed at one end of one of the rollers 12, and having one side abutting against the conveyer belt 13. The presence of the regulation component 10 prevents deviation of the conveyer belt 13 from its normal position during movement. However, inclusion of the regulation component 10 results in a relatively high manufacturing cost of the conventional conveying device 1. Moreover, wear between the conveyer belt 13 and the regulation component 10 is likely to cause damage to the conveyer belt 13 after long-term use.

U.S. Pat. No. 6,411,792B2 discloses a conventional drive roller 2 for an image forming device as illustrated in FIG. 3. The image forming device includes a conveyer belt (not shown) trained on the drive roller 2. The conventional drive roller 2 is formed in a crown shape, i.e., the drive roller 2 has smallest cross-sectional diameters (A, C) at opposite longitudinal ends thereof and a largest cross-sectional diameter (B) at the middle portion thereof, such that deviation of the conveyer belt during its movement around the drive roller can be automatically corrected. However, since the drive roller 2 has to be manufactured precisely in the abovementioned crown shape, the manufacturing cost of the drive roller 2 is relatively high.

U.S. Pat. No. 5,365,321 discloses another conventional conveying device that includes a drive roller and a conveyer belt trained thereon. The drive roller has longitudinally opposite end portions, each of which is provided with a guide member having a friction factor higher than that of the middle portion of the drive roller, such that deviation of the conveyer belt during its movement around the drive roller can be automatically corrected. However, the presence of the guide members results in a relatively large size of the conventional conveying device.

U.S. Pat. No. 5,017,969 discloses still another conventional conveying device that includes a drive roller and a conveyer belt trained thereon. The conveyer belt is provided with a guide rib, while the drive roller is formed with a guide groove. Since the guide rib is retained slidably in the guide groove, the conveyer belt can move around the drive roller without deviation. However, once the guide rib is separated from the guide groove and the conveyer belt deviates from its normal position during movement around the drive roller, the conveyer belt can not be automatically drawn back to the normal position.

U.S. Pat. No. 6,078,766 discloses yet another conventional conveying device having a self-adjustment mechanism that can draw a conveyer belt from a deviated position to a normal position during movement of the conveyer belt around a drive roller. However, the presence of the self-adjustment mechanism results in a relatively complicated structure and a relatively high manufacturing cost of this conventional conveying device.

### SUMMARY OF THE INVENTION

Therefore, an object of the present invention is to provide a drive roller for an image forming device that can automatically draw a conveyer belt trained thereon from a deviated position to a normal position during movement of the conveyer belt around the drive roller, and that has a relatively simple structure and a relatively low manufacturing cost.

Another object of the present invention is to provide a conveying module for an image forming device that includes a drive roller capable of automatically drawing a conveyer belt trained thereon from a deviated position to a normal position during movement of the conveyer belt around the drive roller.

Accordingly, a drive roller of the present invention is adapted for use with an image forming device that includes a conveyer belt trained on the drive roller. The drive roller comprises an elongated roller body and symmetrical first and second threads. The roller body has a first segment that has an annular first surrounding surface, and a second segment that is opposite to the first segment, that has a length equal to that of the first segment, and that has an annular second surrounding surface. The first and second threads are formed respectively at the first and second surrounding surfaces, are threaded in opposite directions, and are adapted for contacting the conveyer belt.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional conveying device disclosed in U.S. Pat. No. 6,088,566;

FIG. 2 is a perspective view of a regulation component of the conventional conveying device disclosed in U.S. Pat. No. 6,088,566;

FIG. 3 is a side view of a conventional drive roller disclosed in U.S. Pat. No. 6,411,792 B2;

FIG. 4 is a perspective view of a first preferred embodiment of a conveying module according to the invention;

FIG. 5 is a side view of a drive roller of the first preferred embodiment;

FIG. 6 is a schematic top view of the first preferred embodiment, illustrating a conveyer belt deviated from its normal position in a direction parallel to the drive roller;

FIG. 7 is another schematic top view of the first preferred embodiment, illustrating the conveyer belt deviated from its normal position in an opposite direction;

FIG. 8 is a side view of a drive roller of a second preferred embodiment of the conveying module according to the invention; and

FIG. 9 is a side view of a drive roller of a third preferred embodiment of the conveying module according to the invention.

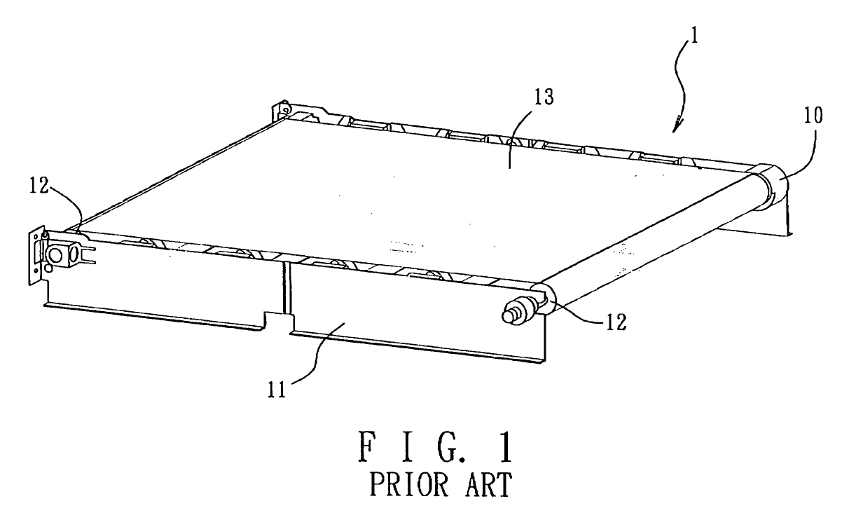

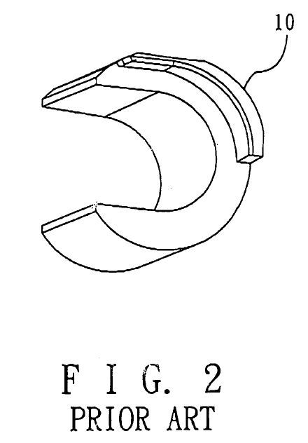

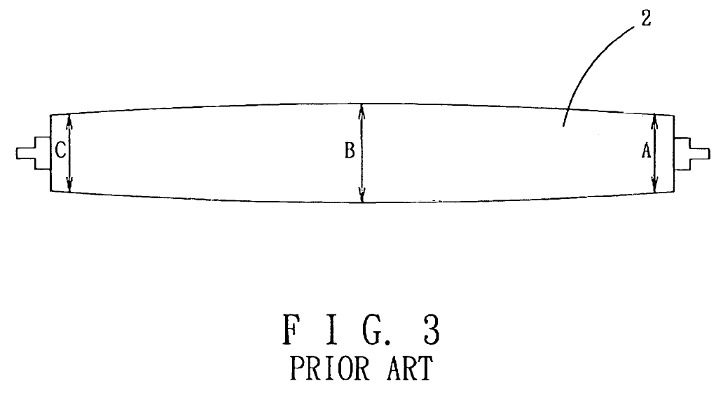

### DETAILED DESCRIPTION OF THE PREFERRED EMBODIMENTS

Before the present invention is described in greater detail, it should be noted that like elements are denoted by the same reference numerals throughout the disclosure.

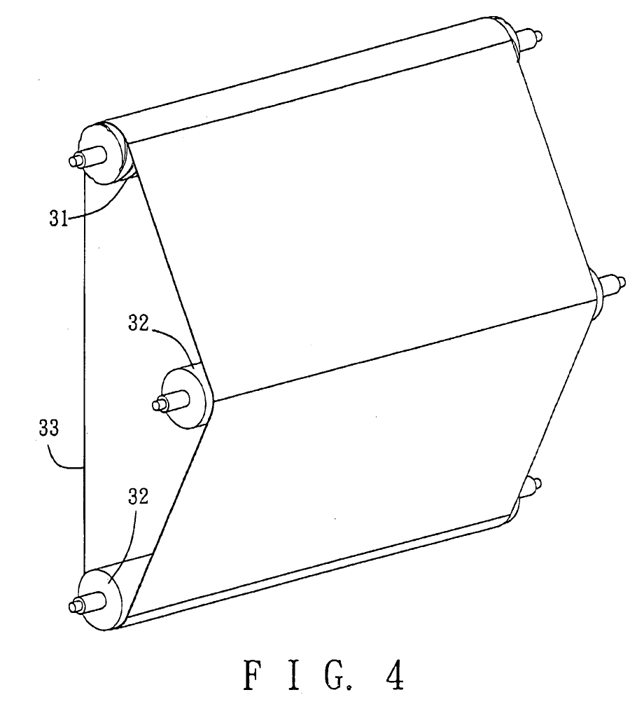

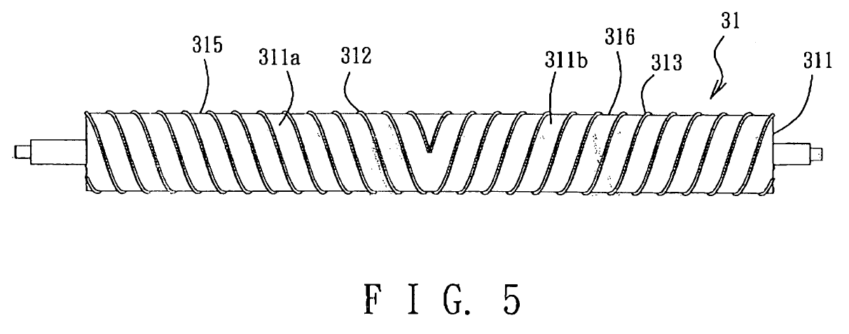

As shown in FIGS. 4 and 5, the first preferred embodiment of a conveying module according to the present invention is adapted for use with an image forming device, and comprises a drive roller 31, a pair of driven rollers 32 spaced apart from the drive roller 31, a conveyer belt 33 trained on the drive roller 31 and the driven rollers 32, and a power source (not shown) for driving rotation of the drive roller 31 and, therefore, movement of the conveyer belt 33 around the drive roller 31 and the driven rollers 32. The conveyer belt 33 may be a photoreceptor belt, an intermediate belt, or a transfer belt.

As best shown in FIG. 5, the drive roller 31 includes an elongated roller body 311 and symmetrical first and second threads 312, 313. The roller body 311 has a first segment 311a that has an annular first surrounding surface 315, and a second segment 311b that is opposite to the first segment 311a, that is connected to the first segment 311a, that has a length equal to that of the first segment 311a, and that has an annular second surrounding surface 316. The first and second threads 312, 313 are formed respectively at the first and second surrounding surfaces 315, 316, are threaded in opposite directions, and are adapted for contacting the conveyer belt 33. In this embodiment, the first thread 312 is a right-handed thread, while the second thread 313 is a left-handed thread. The first thread 312 cooperates with the second thread 313 to form a continuous thread. In this embodiment, the first and second threads 312, 313 are external threads protruding respectively from the first and second surrounding surfaces 315, 316. In this embodiment, the first and second threads 312, 313 are made of a flexible material, such as rubber.

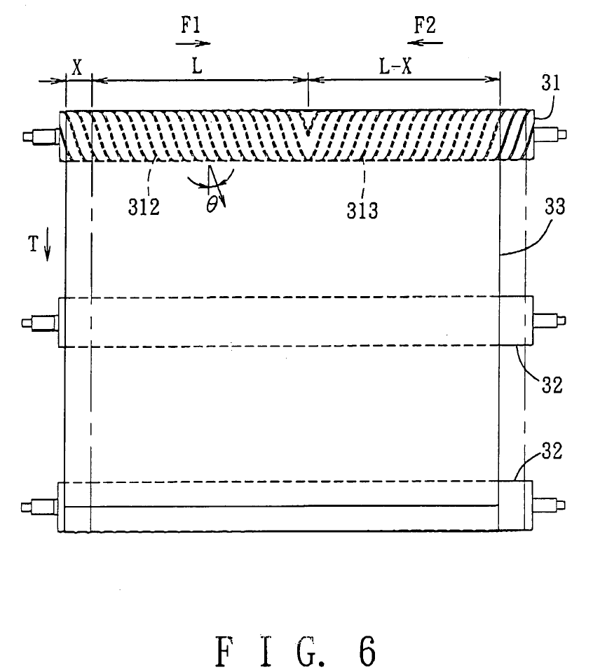

Referring to FIGS. 5 and 6, for example, if the conveyer belt 33 deviates relative to the drive roller 31 toward the left side of FIG. 6 by a distance (X) during movement around the drive roller 31, the forces exerted on the drive roller 31 can be calculated from the following formulas:

$$F 1 = \frac{L + X}{L} \cdot T \cdot tan θ$$

$$F 2 = \frac{L - X}{L} \cdot T \cdot tan θ$$

where F1 is the force exerted on the conveyer belt 33 by the first segment 311a of the roller body 311, F2 is the force exerted on the conveyer belt 33 by the second segment 311b of the roller body 311, L is the length of each of the first and second segments 311a, 311b, and θ is the lead angle of each of the first and second threads 312, 313. Since the first and second threads 312, 313 are threaded in opposite directions, the forces (F1, F2) are exerted on the conveyer belt 33 by the drive roller 31 in opposite directions. Therefore, the resultant force (ΔF) can be obtained from the formula:

$$Δ F = ( F 1 - F 2 ) = \frac{2 X}{L} \cdot T \cdot tan θ$$

where the resultant force (ΔF) is the force exerted on the conveyer belt 33 by the drive roller 31 in a direction opposite to the direction in which the conveyer belt 33 deviates. Therefore, the conveyer belt 33 will be automatically drawn back to its normal position by virtue of the resultant force (ΔF).

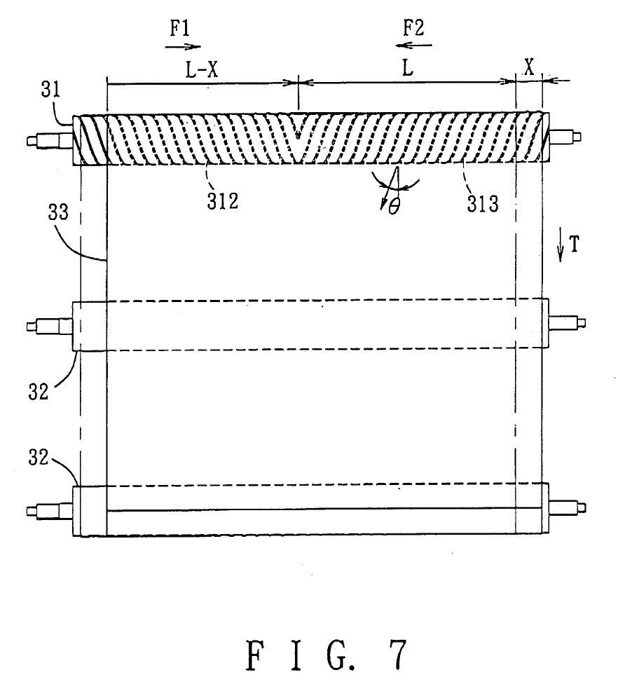

On the contrary, referring to FIG. 7, if the conveyer belt 33 deviates relative to the drive roller 31 toward the right side of FIG. 6 by a distance (X) during movement around the drive roller 31, the forces exerted on the drive roller 31 can be calculated from the following formulas:

$$F 1 = \frac{L - X}{L} \cdot T \cdot tan θ$$

$$F 2 = \frac{L + X}{L} \cdot T \cdot tan θ$$

Afterward, the resultant force (ΔF) can be obtained from the formula:

$$Δ F = ( F 1 - F 2 ) = - \frac{2 X}{L} \cdot T \cdot tan θ$$

where the resultant force (ΔF) is also the force exerted on the conveyer belt 33 by the drive roller 31 in a direction opposite to the direction in which the conveyer belt 33 deviates. Therefore, the conveyer belt 33 will also be automatically drawn back to its normal position by virtue of the resultant force (ΔF).

Compared to the aforementioned prior arts, the first and second threads 312, 313 are simpler in structure, and are easy to be formed respectively on the first and second surrounding surfaces 315, 316 of the roller body 311 of the drive roller 31, thereby resulting in a lower manufacturing cost of the conveying module of this invention.

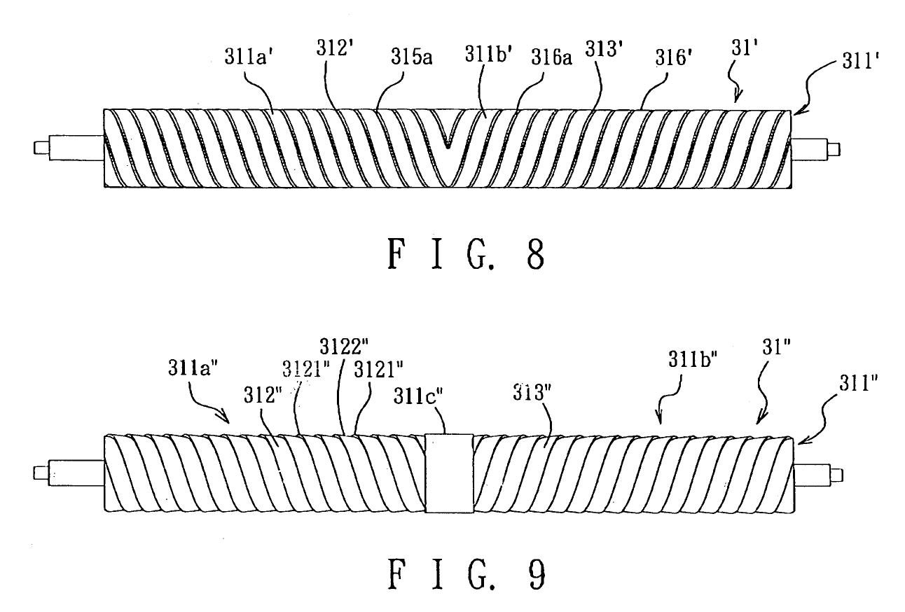

As shown in FIG. 8, the second preferred embodiment of the conveying module according to the present invention has a structure similar to that of the first embodiment. The main difference between this embodiment and the previous embodiment resides in the following. The conveying module of this preferred embodiment has a drive roller 31′ including an elongated roller body 311′ and symmetrical first and second threads 312′, 313′. The roller body 311′ has a first segment 311a′ that has an annular outer peripheral portion made of a flexible material and formed with an annular first surrounding surface 315′, and a second segment 311b′ that is opposite to the first segment 311a′, that is connected to the first segment 311a′, that has a length equal to that of the first segment 311a′, and that has an annular outer peripheral portion made of a flexible material and formed with an annular second surrounding surface 316′. The first and second threads 312′, 313′ are formed respectively at the first and second surrounding surfaces 315′, 316′, are threaded in opposite directions, and are adapted for contacting a conveyer belt (not shown). In this embodiment, the first and second threads 312′, 313′ are respectively portions of the first and second surrounding surfaces 315′, 316′, and are defined respectively by two helical slots 315a, 316a formed respectively in the first and second surrounding surfaces 315′, 316′. The second preferred embodiment has the same advantages as those of the first preferred embodiment.

As shown in FIG. 9, the third preferred embodiment of the conveying module according to the present invention has a structure similar to the first preferred embodiment. The main difference between this embodiment and the first preferred embodiment resides in the following. The conveying module of this preferred embodiment has a drive roller 31″ including an elongated roller body 311″ and symmetrical first and second threads 312″, 313″. The roller body 311″ has a first segment 311a″, a second segment 311b″ that is opposite to the first segment 311a″ and that has a length equal to that of the first segment 311a″, and an intermediate segment 311c″ that interconnects the first and second segments 311a″, 311b″. The first and second threads 312″, 313″ are formed respectively on the first and second segments 311a″, 311b″, are threaded in opposite directions, and are adapted for contacting a conveyer belt (not shown). In this embodiment, each thread pitch portion of each of the first and second threads 312″, 313″ has an adjacent pair of peak portions 3121″ that are respectively proximate to and distal from the intermediate segment 311c″, and a valley portion 3122″ that is formed between the peak portions 3121″ and that has a diameter reducing gradually in a direction toward the peak portion 3121″ proximate to the intermediate segment 311c″. The third preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A drive roller adapted for use with an image forming device that includes a conveyer belt trained on said drive roller, said drive roller comprising:
an elongated roller body having a first segment that has an annular first surrounding surface, and a second segment that is opposite to said first segment, that has a length equal to that of said first segment, and that has an annular second surrounding surface; and
symmetrical first and second threads formed respectively at said first and second surrounding surfaces, threaded in opposite directions, and adapted for contacting the conveyer belt.

2. The drive roller as claimed in claim 1, wherein said first and second threads are external threads protruding respectively from said first surrounding surface of said first segment of said roller body and said second surrounding surface of said second segment of said roller body.

3. The drive roller as claimed in claim 2, wherein said first and second threads are made of a flexible material.

4. The drive roller as claimed in claim 1, wherein:
said first and second segments of said roller body are connected to each other; and
said first thread cooperates with said second thread to form a continuous thread.

5. The drive roller as claimed in claim 1, wherein said first and second threads are respectively portions of said first surrounding surface of said first segment of said roller body and said second surrounding surface of said second segment of said roller body, and are defined respectively by two helical slots formed respectively in said first and second surrounding surfaces.

6. The drive roller as claimed in claim 5, wherein:
said first segment of said roller body has an annular outer peripheral portion made of a flexible material and formed with said first surrounding surface; and
said second segment of said roller body has an annular outer peripheral portion made of the flexible material and formed with said second surrounding surface.

7. The drive roller as claimed in claim 2, wherein said roller body further has an intermediate segment interconnecting said first and second segments.

8. The drive roller as claimed in claim 7, wherein each thread pitch portion of each of said first and second threads has an adjacent pair of peak portions that are respectively approximate to and distal from said intermediate segment of said roller body, and a valley portion that is formed between said peak portions and that has a diameter reducing gradually in a direction toward said peak portion proximate to said intermediate segment.

9. A conveying module for an image forming device, comprising;
a drive roller including
an elongated roller body having a first segment that has an annular first surrounding surface, and a second segment that is opposite to said first segment, that has a length equal to that of said first segment, and that has an annular second surrounding surface,
symmetrical first and second threads formed respectively at said first and second surrounding surfaces, and threaded in opposite directions;
a driven roller spaced apart from said drive roller; and
a conveyer belt trained on said drive roller and said driven roller, and contacting said first and second threads of said drive roller.

10. The conveying module as claimed in claim 9, wherein said first and second threads of said drive roller are external threads protruding respectively from said first surrounding surface of said first segment of said roller body and said second surrounding surface of said second segment of said roller body.

11. The conveying module as claimed in claim 10, wherein said first and second threads of said drive roller are made of a flexible material.

12. The conveying module as claimed in claim 9, wherein:
said first and second segments of said roller body of said drive roller are connected to each other; and
said first thread cooperates with said second thread to form a continuous thread.

13. The conveying module as claimed in claim 9, wherein said first and second threads of said drive roller are respectively portions of said first surrounding surface of said first segment of said roller body and said second surrounding surface of said second segment of said roller body, and are defined respectively by two helical slots formed respectively in said first and second surrounding surfaces.

14. The conveying module as claimed in claim 13, wherein:
said first segment of said roller body has an annular outer peripheral portion made of a flexible material and formed with said first surrounding surface; and
said second segment of said roller body of said drive roller has an annular outer peripheral portion made of the flexible material and formed with said second surrounding surface.

15. The conveying module as claimed in claim 10, wherein said roller body of said drive roller further has an intermediate segment interconnecting said first and second segments.

16. The conveying module as claimed in claim 15, wherein each thread pitch portion of each of said first and second threads of said drive roller has an adjacent pair of peak portions that are respectively approximate to and distal from said intermediate segment of said roller body of said drive roller, and a valley portion that is formed between said peak portions and that has a diameter reducing gradually in a direction toward said peak portion proximate to said intermediate segment.
